(19) United States
(12) Patent Application Publication
(10) Pub. No.: US 2025/0154835 A1
(43) Pub. Date: May 15, 2025

(54) Wrench Assembly

(71) Applicant: Caterpillar Global Mining Equipment LLC, Denison, TX (US)

(72) Inventors: Yagneshwar NATARAJAN, Perungudi (IN); Roberto Garcia, Sherman, TX (US); Charles Taylor Hudson, Sherman, TX (US); Pandidurai P., Madurai (IN)

(73) Assignee: Caterpillar Global Mining Equipment LLC, Denison, TX (US)

(21) Appl. No.: 18/941,403

(22) Filed: Nov. 8, 2024

(30) Foreign Application Priority Data
Nov. 10, 2023 (AU) 2023263550

(51) Int. Cl. E21B 19/16; B23P 19/06

(52) U.S. Cl. CPC E21B 19/161; B23P 19/06

(57) ABSTRACT

A wrench assembly for a machine includes a wrench base including a first surface and a second surface opposite the first surface. The wrench base defines a first central opening extending from the first surface to the second surface and a slot extending from at least one of the first surface and the second surface. The wrench assembly also includes an insert removably coupled to the wrench base. The insert includes a third surface and a fourth surface opposite the third surface. The insert defines a second central opening extending from the third surface to the fourth surface. The second central opening is adapted to receive a portion of a component associated with the machine. The insert is received within the slot in the wrench base. The wrench assembly further includes a plurality of fastening elements that removably couple the insert with the wrench base.

### TECHNICAL FIELD

The present disclosure relates to a wrench assembly, and more particularly, to the wrench assembly for a drilling machine.

### BACKGROUND

A drilling machine, such as a rotary drilling machine or a down-the-hole hammer drilling machine, includes multiple components for performing one or more drilling operations at a worksite. For example, the drilling machine is often used in applications, such as drilling blast holes or geothermal wells. The components of a drilling set-up may include drill pipes, a hammer, and/or a sub adapter. In order to perform drilling operations, multiple drill pipes are joined to achieve a sufficient length equal to a depth of a drill hole.

Generally, deck wrenches are used to hold components during coupling and separating such components. Such deck wrenches are typically costly as the entire deck wrench is made of high carbon, high strength, heat treatable steel. Further, the deck wrenches may wear out over a period of time, due to which the deck wrenches may have to be replaced. The deck wrenches are heavy and difficult to handle, which may require additional tooling and operator assistance in dismantling and replacement of the deck wrenches.

Moreover, the process of removal of the deck wrenches includes a number of process steps, which may be time consuming and may increase machine downtime. Further, frequent replacement of the deck wrenches may increase an operating cost of the drilling machine. It may be desirable to drill holes of different diameters at the worksite due to which different sizes of deck wrenches may be required to couple or remove drill pipes/hammers of different sizes, that may lead to increase in part numbers and inventory costs. Further, the deck wrenches may be difficult to handle while manufacturing, especially when a heat treatment process is to be performed on the deck wrenches.

U.S. Pat. No. 7,621,202 discloses an apparatus. The apparatus is directed to a replacement cage assembly to modify a conventional power tong to enable the power tong to grip and rotate smaller diameter tubular segments. The method of the invention is directed to modifying a power tong to grip and rotate a tubular segment of a diameter smaller than could be gripped by the unmodified power tong. The invention provides a rotary gear insert, having an interior second cam surface, rotatably captured intermediate an upper cage plate and a lower cage plate and slidably receivable within the conventional rotary gear of the power tong and to cam and rotate a plurality of replacement gripping jaws pivotally captured adjacent the second cam surface and intermediate the upper cage plate and the lower cage plate.

### SUMMARY OF THE DISCLOSURE

In an aspect of the present disclosure, a wrench assembly for a machine is provided. The wrench assembly includes a wrench base including a first surface and a second surface opposite the first surface. The wrench base defines a first central opening extending from the first surface to the second surface and a slot extending from at least one of the first surface and the second surface. The wrench base extends along a longitudinal axis, a lateral axis orthogonal to the longitudinal axis, and a vertical axis orthogonal to the longitudinal axis. The wrench assembly also includes an insert removably coupled to the wrench base. The insert includes a third surface and a fourth surface opposite the third surface. The insert defines a second central opening extending from the third surface to the fourth surface. The second central opening is adapted to receive a portion of a component associated with the machine. The insert is received within the slot in the wrench base. The insert engages with the wrench base to prevent a movement of the insert along the longitudinal axis and at least one of the lateral axis and the vertical axis. The wrench assembly further includes a plurality of fastening elements that removably couple the insert with the wrench base.

In another aspect of the present disclosure, a drilling machine is provided. The drilling machine includes a mast assembly. The drilling machine also includes a drill head movable relative to the mast assembly. The drilling machine further includes a component adapted to be coupled to the drill head to perform a drilling operation. The drilling machine includes a wrench assembly adapted to engage with the component during at least one of coupling and removing the component from the drill head. The wrench assembly includes a wrench base including a first surface and a second surface opposite the first surface. The wrench base defines a first central opening extending from the first surface to the second surface and a slot extending from at least one of the first surface and the second surface. The wrench base extends along a longitudinal axis, a lateral axis orthogonal to the longitudinal axis, and a vertical axis orthogonal to the longitudinal axis. The wrench assembly also includes an insert removably coupled to the wrench base. The insert includes a third surface and a fourth surface opposite the third surface. The insert defines a second central opening extending from the third surface to the fourth surface. The second central opening is adapted to receive a portion of a component associated with the machine. The insert is received within the slot in the wrench base. The insert engages with the wrench base to prevent a movement of the insert along the longitudinal axis and at least one of the lateral axis and the vertical axis. The wrench assembly further includes a plurality of fastening elements that removably couple the insert with the wrench base.

Other features and aspects of this disclosure will be apparent from the following description and the accompanying drawings.

### BRIEF DESCRIPTION OF THE DRAWINGS

FIG. 1 is a schematic side view of an exemplary drilling machine, according to an example of the present disclosure;

FIG. 2 is a schematic perspective view of a portion of the drilling machine of FIG. 1, according to an example of the present disclosure;

FIGS. 3A and 3B are schematic perspective views of a wrench assembly associated with the drilling machine of FIG. 1, according to an example of the present disclosure;

FIG. 4A is a schematic top view of a wrench base of the wrench assembly of FIGS. 3A and 3B;

FIG. 4B is a schematic top view of an insert of the wrench assembly of FIGS. 3A and 3B;

FIG. 5 illustrates a schematic perspective view of the wrench assembly of FIGS. 3A and 3B coupled with a component of the drilling machine of FIG. 1, according to an example of the present disclosure;

FIG. 6 is a schematic perspective view of a wrench assembly associated with the machine of FIG. 1, according to another example of the present disclosure;

FIG. 7 is an exploded perspective view of the wrench assembly of FIG. 6;

FIG. 8 is a schematic perspective view of a wrench assembly associated with the machine of FIG. 1, according to yet another example of the present disclosure;

FIG. 9 is an exploded perspective view of the wrench assembly of FIG. 8;

FIG. 10 is a schematic perspective view of a wrench assembly associated with the machine of FIG. 1, according to yet another example of the present disclosure;

FIGS. 11A and 11B illustrate a wrench assembly associated with the machine of FIG. 1, according to yet another example of the present disclosure; and

FIGS. 12A and 12B illustrate a wrench assembly associated with the machine of FIG. 1, according to yet another example of the present disclosure.

### DETAILED DESCRIPTION

Wherever possible, the same reference numbers will be used throughout the drawings to refer to the same or like parts.

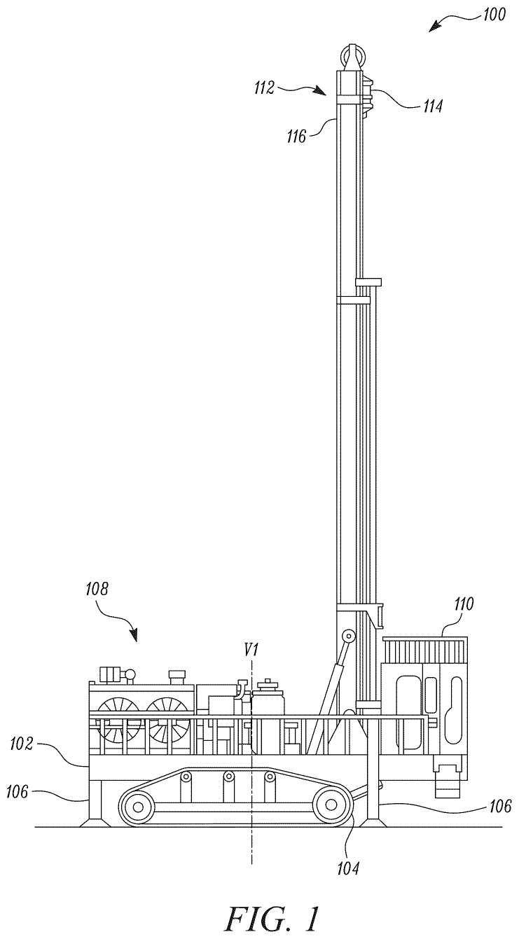

Referring to FIG. 1, a schematic side view of an exemplary drilling machine 100 is illustrated. The drilling machine 100 may be interchangeably referred to as “machine 100”. The machine 100 may perform one or more drilling operations, such as drilling holes, mining blast holes or geothermal wells, and the like. The machine 100 may include a rotary drilling machine or a down-the-hole hammer drilling machine. In the illustrated example of FIG. 1, the machine 100 is embodied as the rotary drilling machine. The machine 100 defines a first axis “F1”. The first axis “F1” extends generally in a vertical direction.

As shown in FIG. 1, the machine 100 includes a frame 102. The frame 102 may be supported on a ground surface by a transport mechanism, such as, crawler tracks 104. The crawler tracks 104 may allow the machine 100 to maneuver on the ground surface to a desired location for a drilling operation. Alternatively, the machine 100 may include wheels/drums instead of the crawler tracks 104. The frame 102 further includes one or more jacks 106 for supporting and leveling the machine 100 on the ground surface during the drilling operation. The machine 100 also includes a machinery 108. The frame 102 may support the machinery 108, which may include various components (not shown herein), such as, a power source (for example, an internal combustion engine or a battery system), motors, batteries, pumps, air compressors, and/or any other equipment necessary to supply power to operate the machine 100. The frame 102 further supports an operator cab 110, from which an operator may maneuver and control the machine 100.

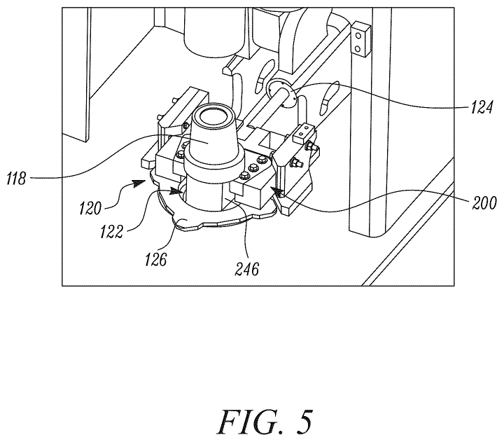

The machine 100 further includes a mast assembly 112. The mast assembly 112 may be supported by the frame 102 of the machine 100. The mast assembly 112 extends along the first axis “F1”. The machine 100 includes a drill head 114 movable relative to the mast assembly 112. Particularly, the drill head 114 is movable relative to the first axis “F1”. The drill head 114 may be supported on a mast frame 116. The machinery 108 may provide necessary power to operate the drill head 114 relative to the mast assembly 112. In some examples, the machine 100 may include one or more motors associated with the drill head 114. The machine 100 also includes a component 118 (shown in FIG. 5) coupled to the drill head 114 to perform the drilling operation. The component 118 may include a drill pipe, a hammer, and/or a sub adapter. For example, when the machine 100 includes the rotary drilling machine, multiple drill pipes may be connected to each other to perform the drilling operation. Further, when the machine 100 includes the down-the-hole hammer drilling machine, the machine 100 may include multiple drill pipes and a hammer connected to an end drill pipe, such that the hammer contacts the ground surface to perform the drilling operation.

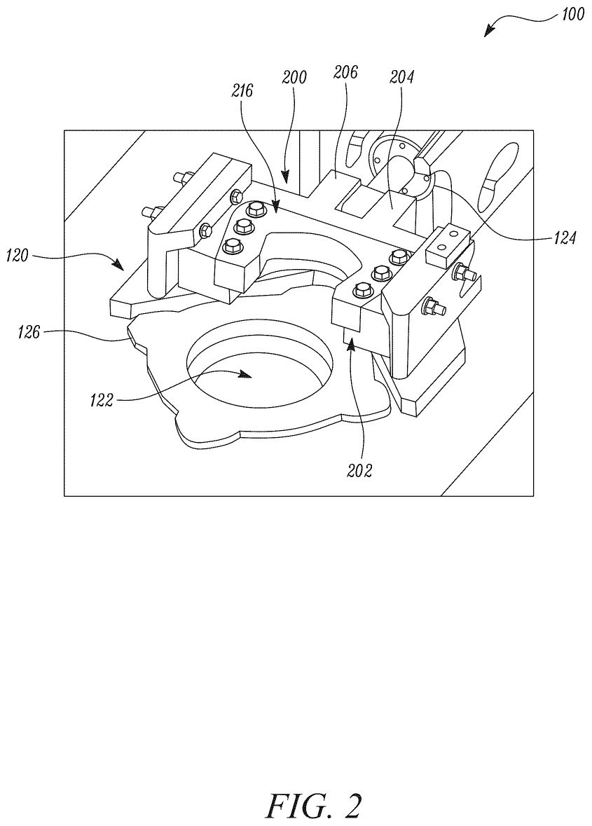

Referring to FIG. 2, a schematic perspective view of a portion of the machine 100 of FIG. 1 is illustrated. The machine 100 includes a deck 120 fixedly coupled to a base of the mast assembly 112 (see FIG. 1) that is in turn pivotally coupled to the frame 102 (shown in FIG. 1) of the machine 100. The deck 120 includes a deck bushing 126. The deck bushing 126 defines a deck hole 122. The deck hole 122 may at least partially receive the component 118 (shown in FIG. 5) therein. The machine 100 also includes a wrench assembly 200 that engages with the component 118 during coupling and/or removing the component 118 from the drill head 114 (see FIG. 1). Although the machine 100 includes the rotary drilling machine herein, the wrench assembly 200 may be associated with a down-the-hole hammer drilling machine. The wrench assembly 200 is movable between a retracted position and an extended position (shown in FIG. 5). The wrench assembly 200 is movable between the retracted position and the extended position by means of a hydraulic cylinder 124. The wrench assembly 200 may be moved to the extended position during coupling and/or removing the component 118. The wrench assembly 200 is shown in the partially extended position in FIG. 2. Further, the wrench assembly 200 may also engage with the deck bushing 126 to retain the deck bushing 126 in position, while the component 118 is being pulled upward by the drill head 114.

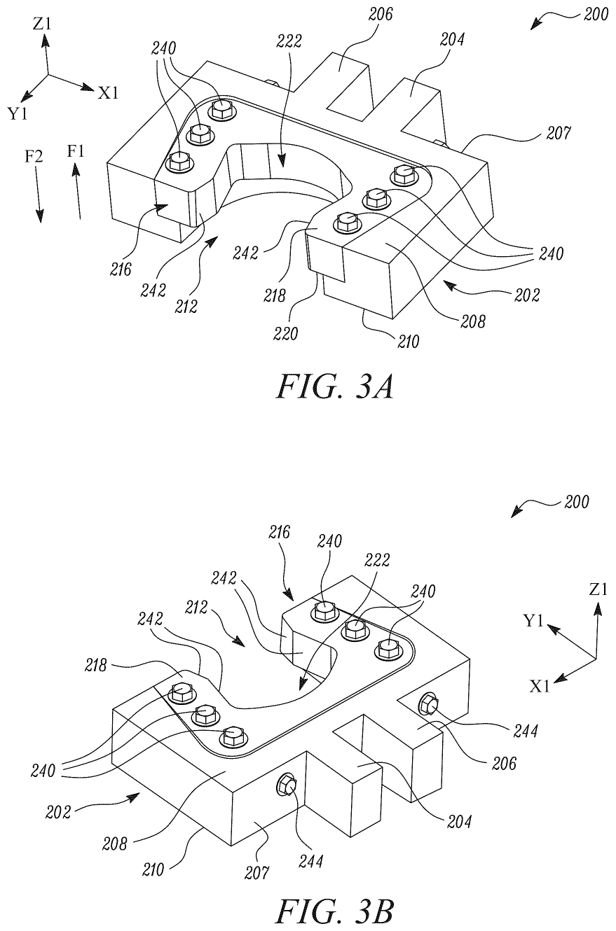

FIGS. 3A and 3B illustrate schematic perspective views of the wrench assembly 200 associated with the machine 100 of FIG. 1. The wrench assembly 200 includes a wrench base 202. The wrench base 202 includes a first surface 208 and a second surface 210 opposite the first surface 208. The first surface 208 is parallel to the second surface 210. The wrench base 202 also includes a first arm 204 and a second arm 206. Each of the first arm 204 and the second arm 206 are fixedly coupled to an outer wall 207 of the wrench base 202.

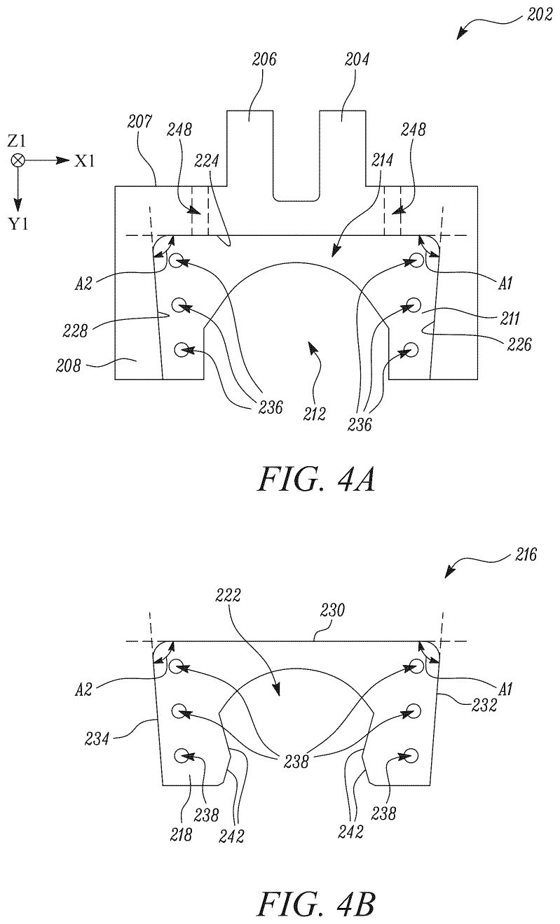

The wrench base 202 defines a first central opening 212 extending from the first surface 208 to the second surface 210. The wrench base 202 also defines a slot 214 (shown in FIG. 4A) extending from the first surface 208 and/or the second surface 210. In the illustrated example of FIGS. 3A and 3B, the slot 214 extends from the first surface 208. The wrench base 202 extends along a longitudinal axis X1, a lateral axis Y1 orthogonal to the longitudinal axis X1, and a vertical axis Z1 orthogonal to the longitudinal axis X1. In some examples, the wrench base 202 may be made of a low carbon steel. In other examples, the wrench base 202 may be made of any metallic material or a composite material, without limiting the scope of the present disclosure.

The wrench assembly 200 also includes an insert 216 removably coupled to the wrench base 202. The insert 216 includes a third surface 218 and a fourth surface 220 opposite the third surface 218. The insert 216 defines a second central opening 222 extending from the third surface 218 to the fourth surface 220. The second central opening 222 receives a portion of the component 118 (shown in FIG. 5) associated with the machine 100. The insert 216 is received within the slot 214 in the wrench base 202. In the illustrated example of FIGS. 3A and 3B, the insert 216 engages with the wrench base 202 to prevent a movement of the insert 216 along the longitudinal axis X1 and the lateral axis Y1. In some examples, the insert 216 may be made of a high carbon steel. In other examples, the insert 216 may be made of any other material that exhibits wear resistant properties, without limiting the scope of the present disclosure.

It should be noted that a size of the second central opening 222 of the insert 216 may be varied to accommodate components (such as the component 118) of different sizes. Accordingly, multiple inserts 216 having different sizes of the second central opening 222 may be manufactured. Thus, the insert 216 may be replaced as and when desired to couple/remove components of different sizes.

The wrench assembly 200 further includes a number of fastening elements 240 that removably couple the insert 216 with the wrench base 202. In some examples, the fastening elements 240 may include a bolt, a screw, a rivet, and the like that removably couples the insert 216 with the wrench base 202. In the illustrated example of FIGS. 3A and 3B, the wrench assembly 200 includes six fastening elements 240 disposed at either sides of the second central opening 222. In other examples, the wrench assembly 200 may include any number of fastening elements 240 based on application attributes.

FIG. 4A is a schematic top view of the wrench assembly 200 of FIGS. 3A and 3B. The wrench base 202 includes a first inner wall 224, a second inner wall 226, and a third inner wall 228. Each of the first inner wall 224, the second inner wall 226, and the third inner wall 228 faces the slot 214 in the wrench base 202. Further, the wrench base 202 defines a bottom surface 211, such that the bottom surface 211 extends from each of the first inner wall 224, the second inner wall 226, and the third inner wall 228. When the insert 216 (see FIGS. 3A and 3B) is received within the slot 214, the insert 216 rests on the bottom surface 211. Each of the second inner wall 226 and the third inner wall 228 extend obliquely relative to the first inner wall 224. The second inner wall 226 and the third inner wall 228 are inclined to each other. As shown in FIG. 4A, the second inner wall 226 is inclined to the first inner wall 224 by an angle A1, and the third inner wall 228 is inclined to the first inner wall 224 by an angle A2. The angles A1, A2 are equal to each other. In some examples, the angles A1, A2 may be greater than 60 degrees but less than 90 degrees.

Further, the wrench base 202 defines a number of first holes 236. In some cases, the first holes 236 may include threaded holes. In the illustrated example of FIG. 4, the wrench base 202 includes six first holes 236. In other examples, the wrench base 202 may include any number of first holes 236 based on application attributes. The first holes 236 are embodied as tapped holes herein.

Referring now to FIG. 4B, the insert 216 includes a first outer wall 230, a second outer wall 232, and a third outer wall 234. Each of the second outer wall 232 and the third outer wall 234 extend obliquely relative to the first outer wall 230. The second outer wall 232 and the third outer wall 234 are inclined to each other. As shown in FIG. 4B, the second outer wall 232 is inclined to the first outer wall 230 by the angle A1, and the third outer wall 234 is inclined to the first outer wall 230 by the angle A2. The second inner wall 226 (See FIG. 4A) of the wrench base 202 (See FIG. 4A) engages with the second outer wall 232 of the insert 216 and the third inner wall 228 (See FIG. 4A) of the wrench base 202 engages with the third outer wall 234 of the insert 216 to removably couple the insert 216 with the wrench base 202 to prevent the movement of the insert 216 along the lateral axis Y1 of the wrench base 202. The insert 216 also includes a pair of engagement portions 242 that face each other. The engagement portions 242 engage with the component 118 (shown in FIG. 5) during coupling or removal of components 118 from the drill head 114 (see FIG. 1). The engagement portions 242 of the insert 216 are heat treated to increase their strength in cases where high carbon alloy steels is used to manufacture the insert 216.

Further, the insert 216 defines a number of second holes 238. In the illustrated example of FIG. 4B, the insert 216 includes six second holes 238. In other examples, the insert 216 may include any number of second holes 238 based on application attributes. The second holes 238 are embodied as through holes herein. The number of second holes 238 of the insert 216 align with a corresponding first hole 236 (See FIG. 4A) from the number of first holes 236 in the wrench base 202 to receive a corresponding fastening element 240 (See FIGS. 3A and 3B) from the number of fastening elements 240.

Referring to FIGS. 3B, 4A, and 4B, the wrench assembly 200 also includes a pair of set screws 244. The wrench base 202 includes a pair of first holes 248 extending from the first inner wall 224 to the outer wall 207 of the wrench base 202. Each first hole 248 receives a corresponding set screw 244. The pair of set screws 244 push and engage the insert 216 against the second and third inner walls 226, 228 of the wrench base 202 to accommodate profile tolerance variation in the insert 216 and the wrench base 202. The set screws 244 are screwed in until the insert 216 tightly fits into the wrench base 202. The fastening elements 240 are coupled to the insert 216 and the wrench base 202 after the set screws 244 are coupled with the insert 216 and the wrench base 202. The set screws 244 may facilitate a wedging action between the insert 216 and the wrench base 202, which may provide a firm joint between the wrench base 202 and the insert 216 when the wrench assembly 200 is subjected to break-out loads.

FIG. 5 illustrates a schematic perspective view of the wrench assembly 200 of FIGS. 3A and 3B coupled with the component 118 of the drilling machine 100 of FIG. 1. The component 118 includes the drill pipe herein.

With reference to FIGS. 2 and 5, the component 118 may be received into the deck hole 122 to perform one or more drilling operations. Since multiple components 118 are required to be coupled and/or removed in order to perform the drilling operations, the wrench assembly 200 may be used to hold the component 118 for coupling and/or removing the component 118 with another vertically adjacent component (not shown herein). In order to engage the wrench assembly 200 with the component 118, the hydraulic cylinder 124 is actuated to move the wrench assembly 200 towards the component 118. Each of the first arm 204 and the second arm 206 of the wrench assembly 200 are coupled to the hydraulic cylinder 124 via a corresponding fastening member (not shown), such as, a pin. Further, the engagement portions 242 (shown in FIG. 3A) on the insert 216 line up against flats 246 of the component 118. Furthermore, a device (not shown) then engages with the vertically adjacent component. The device facilitates coupling/removal of the component 118 with the vertically adjacent component. Further, the hydraulic cylinder 124 retracts the wrench assembly 200 after coupling/removal of the component 118 from the vertically adjacent component.

Referring now to FIGS. 3A and 5, during coupling/removal of the component 118, an upward force F1 or a downward force F2 may be applied on the insert 216 of the wrench assembly 200. The upward force F1 may include a pull-back force that may be inadvertently applied by an operator whereas the downward force F2 may include a pull-down force that may be inadvertently applied by the operator. The insert 216 is coupled and retained within the wrench base 202 such that the insert 216 does not disassemble from the wrench base 202 even if the upward or downward forces F1, F2 are applied on the insert 216. Specifically, the fastening elements 240 may bear the upward forces F1 being applied on the insert 216, while the bottom surface 211 (see FIG. 4A) may bear the downward forces F2 being applied on the insert 216. Moreover, the second and third inner walls 226, 228 bear torque loads experienced by the insert 216 during coupling/removal operation.

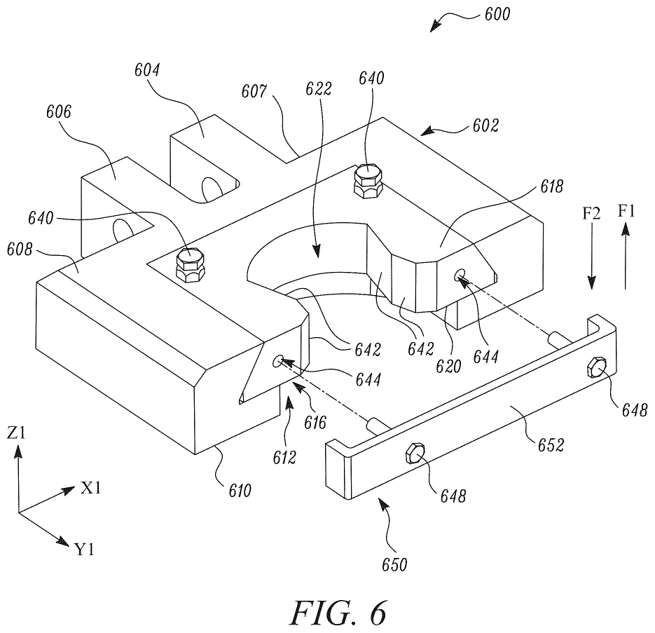

FIG. 6 is a schematic perspective view of a wrench assembly 600 associated with the machine 100 of FIG. 1, according to another example of the present disclosure. The wrench assembly 600 may be substantially and functionally similar to the wrench assembly 200 of FIGS. 2 to 5. The wrench assembly 600 includes a wrench base 602. The wrench base 602 includes a first surface 608 and a second surface 610 opposite the first surface 608. The first surface 608 is parallel to the second surface 610. The wrench base 602 also includes a first arm 604 and a second arm 606. Each of the first arm 604 and the second arm 606 are fixedly coupled to the wrench base 602 at an outer wall 607 of the wrench base 602.

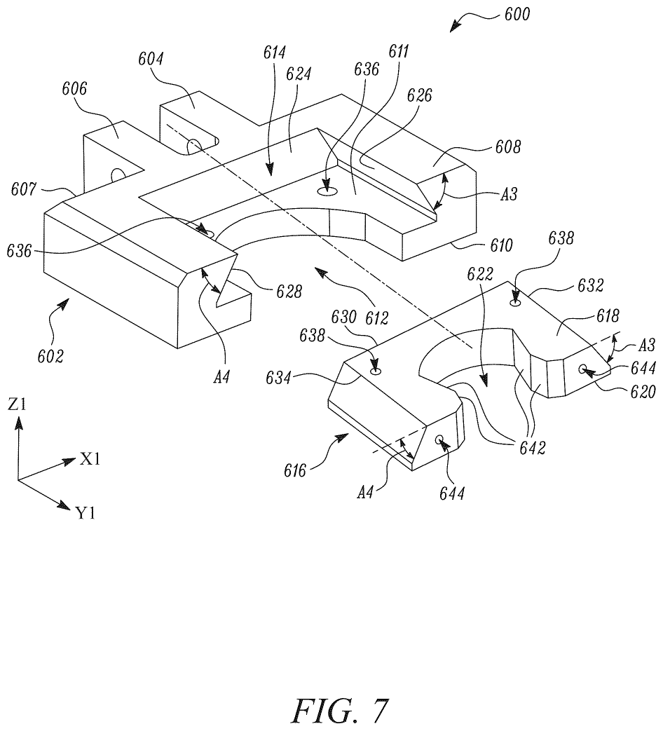

The wrench base 602 defines a first central opening 612 extending from the first surface 608 to the second surface 610. The wrench base 602 also defines a slot 614 (shown in FIG. 7) extending from the first surface 608 and/or the second surface 610. In the illustrated example of FIG. 7, the slot 614 extends from the first surface 608. The wrench base 602 extends along the longitudinal axis X1, the lateral axis Y1 orthogonal to the longitudinal axis X1, and the vertical axis Z1 orthogonal to the longitudinal axis X1.

The wrench assembly 600 also includes an insert 616 removably coupled to the wrench base 602. The insert 616 includes a third surface 618 and a fourth surface 620 opposite the third surface 618. The insert 616 defines a second central opening 622 extending from the third surface 618 to the fourth surface 620. The second central opening 622 receives a portion of the component 118 (shown in FIG. 5) associated with the machine 100. The insert 616 is received within the slot 614 in the wrench base 602. The insert 616 engages with the wrench base 602 to prevent a movement of the insert 616 along the longitudinal axis X1 and the vertical axis Z1.

It should be noted that a size of the second central opening 622 of the insert 616 may be varied to accommodate components (such as the component 118) of different sizes. Accordingly, multiple inserts 616 having different sizes of the second central opening 622 may be manufactured. Thus, the insert 616 may be replaced as and when desired to couple/remove components of different sizes.

The wrench assembly 600 further includes a number of fastening elements 640 that removably couple the insert 616 with the wrench base 602. In some examples, the fastening elements 640 may include a bolt, a screw, a rivet, and the like that removably couples the insert 616 with the wrench base 602. In the illustrated example of FIG. 6, the wrench assembly 600 includes two fastening elements 640 disposed at either sides of the second central opening 622. In other examples, the wrench assembly 600 may include any number of fastening elements 640 based on application attributes.

Referring to FIG. 7, an exploded perspective view of the wrench assembly 600 of FIG. 6 is illustrated. The wrench base 602 includes a first inner wall 624, a second inner wall 626, and a third inner wall 628. Each of the first inner wall 624, the second inner wall 626, and the third inner wall 628 faces the slot 614 in the wrench base 602. Further, the wrench base 602 defines a bottom surface 611, such that the bottom surface 611 extends from each of the first inner wall 624, the second inner wall 626, and the third inner wall 628. When the insert 616 is received within the slot 614, the insert 616 rests on the bottom surface 611.

Each of the second inner wall 626 and the third inner wall 628 extend obliquely relative to the first surface 608 of the wrench base 602. The second inner wall 626 and the third inner wall 628 are inclined to each other. As shown in FIG. 7, the second inner wall 626 is inclined to the first surface 608 by an angle A3, and the third inner wall 628 is inclined to the first surface 608 by an angle A4. The angles A3, A4 are equal to each other. In some examples, the angles A3, A4 may be greater than 30 degrees but less than 90 degrees.

In the illustrated example of FIG. 7, each of the second and third inner walls 626, 628 is orthogonal relative to the first inner wall 624, i.e., an angle between each of the second and third inner walls 626, 628 and the first inner wall 624 is equal to 90 degrees. Alternatively, each of the second and third inner walls 626, 628 may be inclined to the first inner wall 624 by an angle greater than 90 degrees. Such a design of the wrench base 602 may ensure a firm joint between the wrench base 602 and the insert 616.

Further, the wrench base 602 defines a number of first holes 636. In some cases, the first holes 636 may include threaded holes. In the illustrated example of FIG. 7, the wrench base 602 includes two first holes 636. In other examples, the wrench base 602 may include any number of first holes 636 based on application attributes. The first holes 636 are embodied as tapped holes herein.

The insert 616 includes a first outer wall 630, a second outer wall 632, and a third outer wall 634. Each of the second outer wall 632 and the third outer wall 634 extend obliquely relative to the third surface 618 of the insert 616. The second outer wall 632 and the third outer wall 634 are inclined to each other. As shown in FIG. 7, the second outer wall 632 is inclined to the third surface 618 by the angle A3, and the third outer wall 634 is inclined to the third surface 618 by the angle A4. The second inner wall 626 of the wrench base 602 engages with the second outer wall 632 of the insert 616 and the third inner wall 628 of the wrench base 602 engages with the third outer wall 634 of the insert 616 to removably couple the insert 616 with the wrench base 602 to prevent the movement of the insert 616 along the vertical axis Z1 of the wrench base 602. The insert 616 also includes a pair of engagement portions 642 that face each other. The engagement portions 642 engage with the component 118 (shown in FIG. 5) during coupling or removal of components 118 from the drill head 114 (see FIG. 1). The engagement portions 642 of the insert 616 are heat treated to increase their strength in cases where high carbon alloy steels is used to manufacture the insert 616.

In the illustrated example of FIG. 7, each of the second and third outer walls 632, 634 is orthogonal relative to the first outer wall 630, i.e., an angle between each of the second and third outer walls 632, 634 and the first outer wall 630 is equal to 90 degrees. Alternatively, each of the second and third outer walls 632, 634 may be inclined to the first outer wall 630 by an angle greater than 90 degrees. Such a design of the insert 616 may ensure a firm joint between the wrench base 602 and the insert 616.

Further, the insert 616 defines a number of second holes 638. In the illustrated example of FIG. 7, the insert 616 includes two second holes 638. In other examples, the insert 616 may include any number of second holes 638 based on application attributes. The second holes 638 are embodied as through holes herein. The number of second holes 638 of the insert 616 align with a corresponding first hole 636 from the number of first holes 636 in the wrench base 602 to receive a corresponding fastening element 640 (see FIG. 6) from the number of fastening elements 640.

Referring to FIG. 6, the insert 616 includes a number of third holes 644. In the illustrated example of FIG. 7, the insert 616 includes two third holes 644. Each third hole 644 receives a corresponding fastener 648 of a tool 650. The tool 650 is embodied as a pull tool that facilitates lateral removal of the insert 616 from the wrench base 602. The tool 650 includes a U-shaped member 652 and the fasteners 648 that engage with the insert 616 to remove the insert 616 from the wrench base 602, during servicing or replacement procedures.

During coupling/removal of the component 118, the upward force F1 or the downward force F2 may be applied on the insert 616 of the wrench assembly 600. The insert 616 is coupled and retained within the wrench base 602 such that the insert 616 does not disassemble from the wrench base 602 even if the upward or downward forces F1, F2 are applied on the insert 616. Specifically, the second and third inner walls 626, 628 may bear the upward forces F1 being applied on the insert 616, while the bottom surface 611 (see FIG. 7) may bear the downward forces F2 being applied on the insert 616. Moreover, the second and third inner walls 626, 628 bear torque loads experienced by the insert 616 during coupling/removal operation.

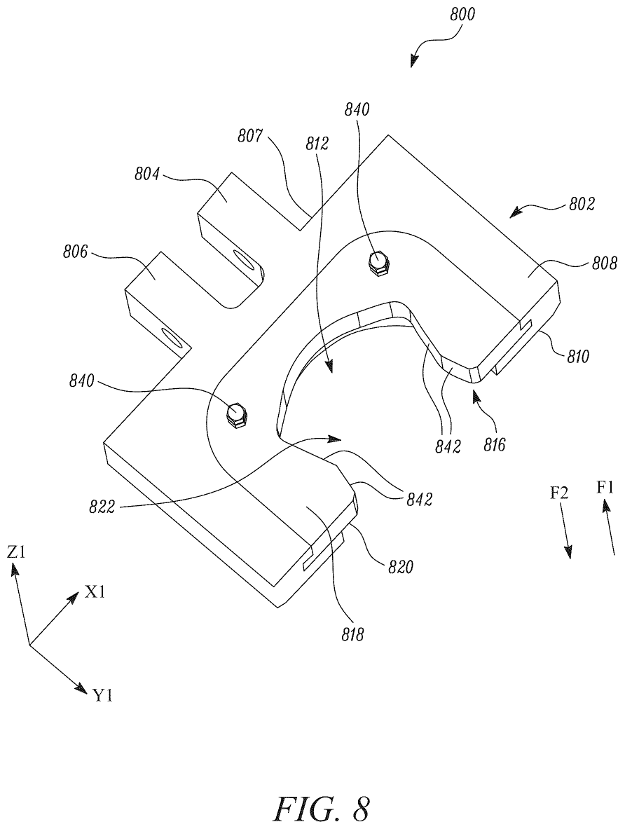

FIG. 8 is a schematic perspective view of a wrench assembly 800 associated with the machine 100 of FIG. 1, according to yet another example of the present disclosure. The wrench assembly 800 may be substantially and functionally similar to the wrench assembly 200 of FIGS. 2 to 5. The wrench assembly 800 includes a wrench base 802. The wrench base 802 includes a first surface 808 and a second surface 810 opposite the first surface 808. The first surface 808 is parallel to the second surface 810. The wrench base 802 also includes a first arm 804 and a second arm 806. Each of the first arm 804 and the second arm 806 are fixedly coupled to the wrench base 802 at an outer wall 807 of the wrench base 802.

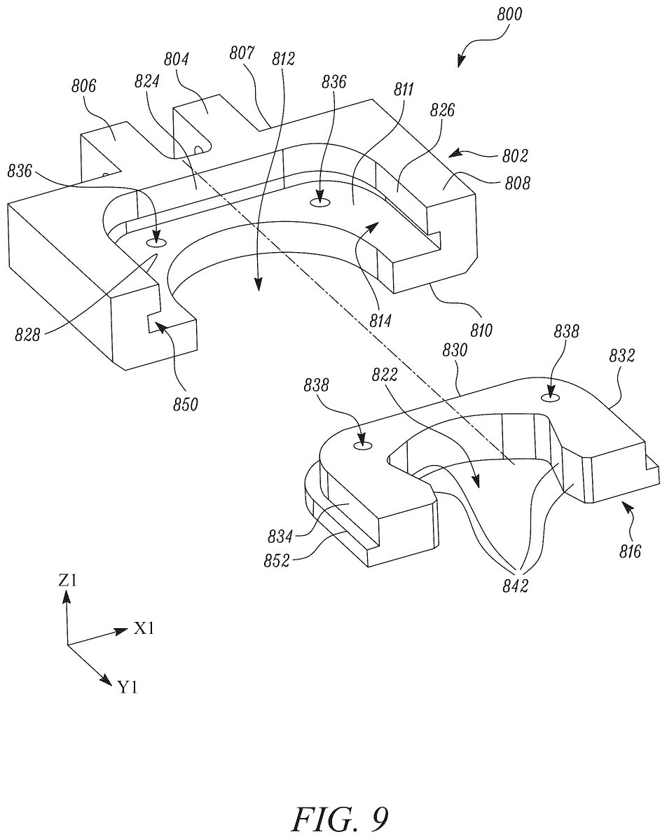

The wrench base 802 defines a first central opening 812 extending from the first surface 808 to the second surface 810. The wrench base 802 also defines a slot 814 (shown in FIG. 9) extending from the first surface 808 and/or the second surface 810. In the illustrated example of FIG. 9, the slot 814 extends from the first surface 808. The wrench base 802 extends along the longitudinal axis X1, the lateral axis Y1 orthogonal to the longitudinal axis X1, and the vertical axis Z1 orthogonal to the longitudinal axis X1.

The wrench assembly 800 also includes an insert 816 removably coupled to the wrench base 802. The insert 816 includes a third surface 818 and a fourth surface 820 opposite the third surface 818. The insert 816 defines a second central opening 822 extending from the third surface 818 to the fourth surface 820. The second central opening 822 receives a portion of the component 118 (shown in FIG. 5) associated with the machine 100. The insert 816 is received within the slot 814 in the wrench base 802. The insert 816 engages with the wrench base 802 to prevent a movement of the insert 816 along the longitudinal axis X1 and the vertical axis Z1.

It should be noted that a size of the second central opening 822 of the insert 816 may be varied to accommodate components (such as the component 118) of different sizes. Accordingly, multiple inserts 816 having different sizes of the second central opening 822 may be manufactured. Thus, the insert 816 may be replaced as and when desired to couple/remove components of different sizes.

The wrench assembly 800 further includes a number of fastening elements 840 that removably couple the insert 816 with the wrench base 802. In some examples, the fastening elements 840 may include a bolt, a screw, a rivet, and the like that removably couples the insert 816 with the wrench base 802. In the illustrated example of FIG. 8, the wrench assembly 800 includes two fastening elements 840 disposed at either sides of the second central opening 822. In other examples, the wrench assembly 800 may include any number of fastening elements 840 based on application attributes.

Referring to FIG. 9, an exploded perspective view of the wrench assembly 800 of FIG. 8 is illustrated. The wrench base 802 includes a first inner wall 824, a second inner wall 826, and a third inner wall 828. Each of the first inner wall 824, the second inner wall 826, and the third inner wall 828 faces the slot 814 in the wrench base 802. The wrench base 802 also includes a groove 850 facing the slot 814. The groove 850 extends from each of the first inner wall 824, the second inner wall 826, and the third inner wall 828 towards the outer wall 807. Further, the wrench base 802 defines a bottom surface 811, such that the bottom surface 811 extends from each of the first inner wall 824, the second inner wall 826, and the third inner wall 828. When the insert 816 is received within the slot 814, the insert 816 rests on the bottom surface 811.

In the illustrated example of FIG. 9, each of the second and third inner walls 826, 828 is orthogonal relative to the first inner wall 824, i.e., an angle between each of the second and third inner walls 826, 828 and the first inner wall 824 is equal to 90 degrees. Alternatively, each of the second and third inner walls 826, 828 may be inclined to the first inner wall 824 by an angle greater than 90 degrees. Such a design of the wrench base 802 may ensure a firm joint between the wrench base 802 and the insert 816.

Further, the wrench base 802 defines a number of first holes 836. In some cases, the first holes 836 may include threaded holes. In the illustrated example of FIG. 9, the wrench base 802 includes two first holes 836. In other examples, the wrench base 802 may include any number of first holes 836 based on application attributes. The first holes 836 are embodied as tapped holes herein.

The insert 816 includes a first outer wall 830, a second outer wall 832, and a third outer wall 834. The insert 816 includes a projection 852 extending orthogonally from each of the first outer wall 830, the second outer wall 832, and the third outer wall 834. The projection 852 is received within the groove 850 in the wrench base 802 to prevent the movement of the insert 816 along the vertical axis Z1 of the wrench base 802. The insert 816 also includes a pair of engagement portions 842 that face each other. The engagement portions 842 engage with the component 118 (shown in FIG. 5) during coupling or removal of components 118 from the drill head 114 (see FIG. 1). The engagement portions 842 of the insert 816 are heat treated to increase their strength in cases where high carbon alloy steels is used to manufacture the insert 816.

In the illustrated example of FIG. 9, each of the second and third outer walls 832, 834 is orthogonal relative to the first outer wall 830, i.e., an angle between each of the second and third outer walls 832, 834 and the first outer wall 830 is equal to 90 degrees. Alternatively, each of the second and third outer walls 832, 834 may be inclined to the first outer wall 830 by an angle greater than 90 degrees. Such a design of the insert 816 may ensure a firm joint between the wrench base 802 and the insert 816.

Further, the insert 816 defines a number of second holes 838. In the illustrated example of FIG. 9, the insert 816 includes two second holes 838. In other examples, the insert 816 may include any number of second holes 838 based on application attributes. The second holes 838 are embodied as through holes herein. The number of second holes 838 of the insert 816 align with a corresponding first hole 836 from the number of first holes 836 in the wrench base 802 to receive a corresponding fastening element 840 (see FIG. 8) from the number of fastening elements 840.

Further, the insert 816 may also include third holes (similar to the third holes 644 of the wrench assembly 600 shown in FIG. 7) that may engage with the tool 650 (see FIG. 6) for lateral removal of the insert 816 from the wrench base 802.

Referring again to FIG. 8, during coupling/removal of the component 118, the upward force F1 or the downward force F2 may be applied on the insert 816 of the wrench assembly 800. The insert 816 is coupled and retained within the wrench base 802 such that the insert 816 does not disassemble from the wrench base 802 even if the upward or downward forces F1, F2 are applied on the insert 816. Specifically, the projection 852 engaging with the groove 850 may bear the upward forces F1 being applied on the insert 816, while the bottom surface 811 (see FIG. 7) may bear the downward forces F2 being applied on the insert 816. Moreover, the second and third inner walls 826, 828 bear torque loads experienced by the insert 816 during coupling/removal operation.

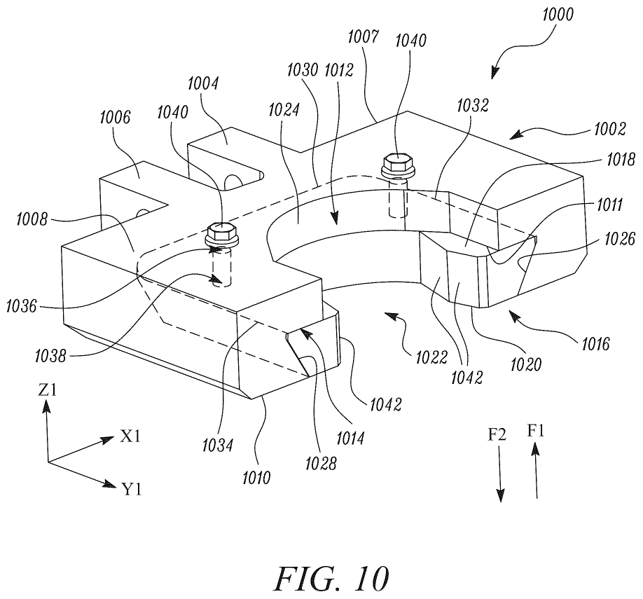

Referring to FIG. 10, a schematic perspective view of a wrench assembly 1000 associated with the machine 100 of FIG. 1 is illustrated, according to yet another example of the present disclosure. The wrench assembly 1000 may be substantially and functionally similar to the wrench assembly 600 of FIGS. 6 and 7. The wrench assembly 1000 includes a wrench base 1002. The wrench base 1002 includes a first surface 1008 and a second surface 1010 opposite the first surface 1008. The first surface 1008 is parallel to the second surface 1010. The wrench base 1002 also includes a first arm 1004 and a second arm 1006. Each of the first arm 1004 and the second arm 1006 are fixedly coupled to the wrench base 1002 at an outer wall 1007 of the wrench base 1002.

The wrench base 1002 defines a first central opening 1012 extending from the first surface 1008 to the second surface 1010. The wrench base 1002 also defines a slot 1014 extending from the first surface 1008 and/or the second surface 1010. In the illustrated example of FIG. 10, the slot 1014 extends from the second surface 1010. The wrench base 1002 extends along the longitudinal axis X1, the lateral axis Y1 orthogonal to the longitudinal axis X1, and the vertical axis Z1 orthogonal to the longitudinal axis X1.

The wrench assembly 1000 also includes an insert 1016 removably coupled to the wrench base 1002. The insert 1016 includes a third surface 1018 and a fourth surface 1020 opposite the third surface 1018. The insert 1016 defines a second central opening 1022 extending from the third surface 1018 to the fourth surface 1020. The second central opening 1022 receives a portion of the component 118 (shown in FIG. 5) associated with the machine 100. The insert 1016 is received within the slot 1014 in the wrench base 1002. The insert 1016 engages with the wrench base 1002 to prevent a movement of the insert 1016 along the longitudinal axis X1 and the vertical axis Z1.

It should be noted that a size of the second central opening 1022 of the insert 1016 may be varied to accommodate components (such as the component 118) of different sizes. Accordingly, multiple inserts 1016 having different sizes of the second central opening 1022 may be manufactured. Thus, the insert 1016 may be replaced as and when desired to couple/remove components of different sizes.

The wrench assembly 1000 further includes a number of fastening elements 1040 that removably couple the insert 1016 with the wrench base 1002. In some examples, the fastening elements 1040 may include a bolt, a screw, a rivet, or the like that removably couples the insert 1016 with the wrench base 1002. In the illustrated example of FIG. 10, the wrench assembly 1000 includes two fastening elements 1040 disposed at either sides of the second central opening 1022. In other examples, the wrench assembly 1000 may include any number of fastening elements 1040 based on application attributes.

The wrench base 1002 includes a first inner wall 1024, a second inner wall 1026, and a third inner wall 1028. Each of the first inner wall 1024, the second inner wall 1026, and the third inner wall 1028 faces the slot 1014 in the wrench base 1002. Further, the wrench base 1002 defines an upper surface 1011, such that the upper surface 1011 extends from each of the first inner wall 1024, the second inner wall 1026, and the third inner wall 1028. When the insert 1016 is received within the slot 1014, the insert 1016 may contact the upper surface 1011. Each of the second inner wall 1026 and the third inner wall 1028 extend obliquely relative to the second surface 1010 of the wrench base 1002. As shown in FIG. 10, the second inner wall 1026 is inclined to the second surface 1010, and the third inner wall 1028 is inclined to the second surface 1010. The second inner wall 1026 and the third inner wall 1028 are inclined to each other.

In the illustrated example of FIG. 10, each of the second and third inner walls 1026, 1028 is orthogonal relative to the first inner wall 1024, i.e., an angle between each of the second and third inner walls 1026, 1028 and the first inner wall 1024 is equal to 90 degrees. Alternatively, each of the second and third inner walls 1026, 1028 may be inclined to the first inner wall 1024 by an angle greater than 90 degrees. Such a design of the wrench base 1002 may ensure a firm joint between the wrench base 1002 and the insert 1016.

Further, the wrench base 1002 defines a number of first holes 1036. In some cases, the first holes 1036 may include threaded holes. In the illustrated example of FIG. 10, the wrench base 1002 includes two first holes 1036. In other examples, the wrench base 1002 may include any number of first holes 1036 based on application attributes. The first holes 1036 are embodied as tapped holes herein.

The insert 1016 includes a first outer wall 1030, a second outer wall 1032, and a third outer wall 1034. Each of the second outer wall 1032 and the third outer wall 1034 extend obliquely relative to the fourth surface 1020 of the insert 1016. As shown in FIG. 10, the second outer wall 1032 is inclined to the fourth surface 1020, and the third outer wall 1034 is inclined to the fourth surface 1020. The second outer wall 1032 and the third outer wall 1034 are inclined to each other. The second inner wall 1026 of the wrench base 1002 engages with the second outer wall 1032 of the insert 1016 and the third inner wall 1028 of the wrench base 1002 engages with the third outer wall 1034 of the insert 1016 to removably couple the insert 1016 with the wrench base 1002 to prevent the movement of the insert 1016 along the vertical axis Z1 of the wrench base 1002. The insert 1016 also includes a pair of engagement portions 1042 that face each other. The engagement portions 1042 engage with the component 118 (shown in FIG. 5) during coupling or removal of components 118 from the drill head 114 (see FIG. 1). The engagement portions 1042 of the insert 1016 are heat treated to increase their strength in cases where high carbon alloy steels is used to manufacture the insert 1016.

In the illustrated example of FIG. 10, each of the second and third outer walls 1032, 1034 is orthogonal relative to the first outer wall 1030, i.e., an angle between each of the second and third outer walls 1032, 1034 and the first outer wall 1030 is equal to 90 degrees. Alternatively, each of the second and third outer walls 1032, 1034 may be inclined to the first outer wall 1030 by an angle greater than 90 degrees. Such a design of the insert 1016 may ensure a firm joint between the wrench base 1002 and the insert 1016.

Further, the insert 1016 defines a number of second holes 1038. In the illustrated example of FIG. 10, the insert 1016 includes two second holes 1038. In other examples, the insert 1016 may include any number of second holes 1038 based on application attributes. The second holes 1038 are embodied as through holes herein. The number of second holes 1038 of the insert 1016 align with a corresponding first hole 1036 from the number of first holes 1036 in the wrench base 1002 to receive a corresponding fastening element 1040 from the number of fastening elements 1040.

Further, the insert 1016 may also include third holes (similar to the third holes 644 of the wrench assembly 600 shown in FIG. 7) that may engage with the tool 650 (see FIG. 6) for lateral removal of the insert 1016 from the wrench base 1002.

During coupling/removal of the component 118, the upward force F1 or the downward force F2 may be applied on the insert 1016 of the wrench assembly 1000. The insert 1016 is coupled and retained within the wrench base 1002 such that the insert 1016 does not disassemble from the wrench base 1002 even if the upward or downward forces F1, F2 are applied on the insert 1016. Specifically, the upper surface 1011 may bear the upward forces F1 being applied on the insert 1016, while the second and third inner walls 1026, 1028 of the wrench base 1002 may bear the downward forces F2 being applied on the insert 1016. Moreover, the second and third inner walls 1026, 1028 bear torque loads experienced by the insert 1016 during coupling/removal operation.

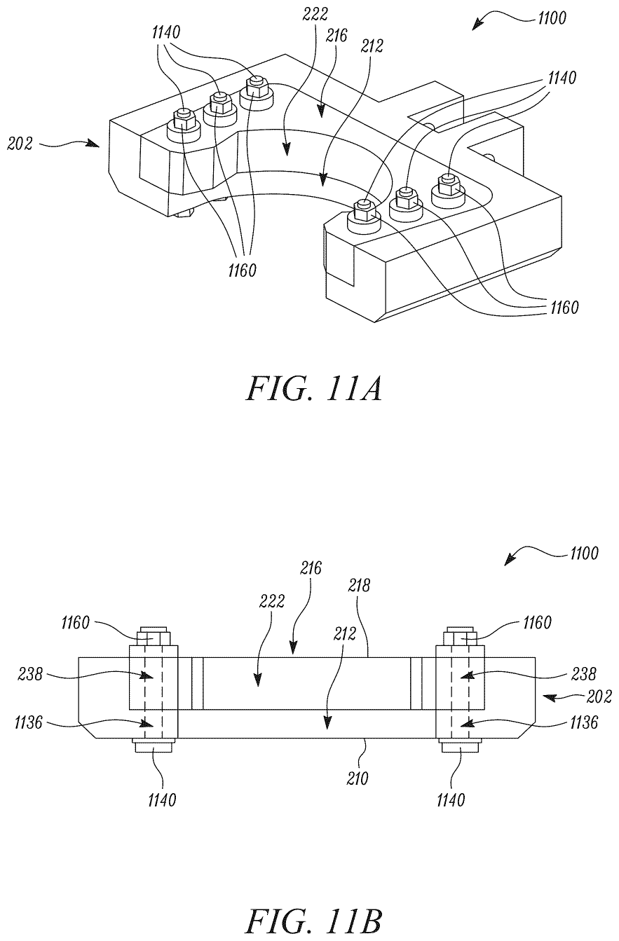

Referring to FIG. 11A, a schematic perspective view of a wrench assembly 1100 associated with the machine 100 of FIG. 1 is illustrated, according to yet another example of the present disclosure. The wrench assembly 1100 may be substantially and functionally similar to the wrench assembly 200 of FIGS. 3A to 4B. Same elements are referred to herein using the same numbers. The wrench assembly 1100 includes the wrench base 202 and the insert 216 explained in relation to FIGS. 3A to 4B.

Referring to FIG. 11B, the wrench base 202 defines a number of first holes 1136. The first holes 1136 are embodied as through holes herein, instead of tapped holes. Further, the insert 216 defines the second holes 238. The wrench assembly 1100 further includes a number of fastening elements 1140 that removably couple the insert 216 with the wrench base 202. In the illustrated example of FIGS. 11A and 11B, the fastening elements 240 include a bolt that removably couples the insert 216 with the wrench base 202. In the illustrated example of FIGS. 11A and 11B, the wrench assembly 1100 includes six fastening elements 1140. In other examples, the wrench assembly 1100 may include any number of fastening elements 1140, based on application attributes.

Further, the wrench assembly 1100 includes a number of nuts 1160. The wrench assembly 1100 includes six nuts 1160. A total number of the nuts 1160 is based on the total number of the fastening elements 1140. As shown in FIG. 11B, a head portion of each fastening element 1140 is disposed adjacent to the second surface 210 and the nut 1160 is disposed adjacent to the third surface 218. Alternatively, the fastening elements 1140 and the nuts 1160 may be assembled such that the head portion of each fastening element 1140 is disposed adjacent to the third surface 218 and the nut 1160 is disposed adjacent to the second surface 210.

Further, in order to accommodate the wrench assembly 1100 on the deck 120 (see FIG. 2) and to prevent any interference of the fastening elements 1140 or the nuts 1160 with the deck 120, the deck 120 may include a pair of slots/passages to allow passage of the fastening elements and the nuts 1160, during extension/retraction of the wrench assembly 1100.

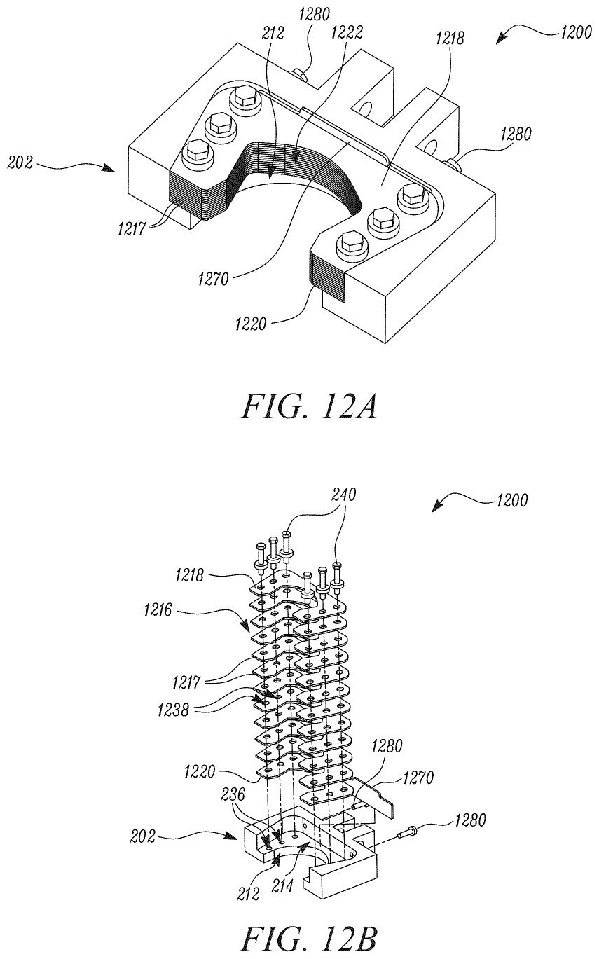

Referring to FIG. 12A, a schematic perspective view of a wrench assembly 1200 associated with the machine 100 of FIG. 1 is illustrated, according to yet another example of the present disclosure. The wrench assembly 1200 may be substantially and functionally similar to the wrench assembly 200 of FIGS. 3A to 4B. Same elements are referred to herein using the same numbers. The wrench assembly 1200 includes the wrench base 202 explained in relation to FIGS. 3A to 4B. Further, the wrench assembly 1200 also includes an insert 1216.

Referring to FIG. 12B, an exploded view of the wrench assembly 1200 is illustrated. The insert 1216 includes a number of insert plates 1217 disposed in a stacked configuration. In other words, the number of insert plates 1217 are stacked on each other to form the insert 1216. Each insert plate 1217 is embodied as a laser cut plate. The insert plates 1217 are received within the slot 214 of the wrench base 202. The insert plate 1217 disposed at the top of the stack defines a third surface 1218 of the insert 1216. Further, the insert plate 1217 disposed at the bottom of the stack defines a fourth surface 1220 of the insert 1216. Furthermore, each insert plate 1217 defines a number of second holes 1238. Specifically, each insert plate 1217 defines six second holes 1238.

The wrench assembly 1200 further includes the six fastening elements 240 that removably couple the insert 1216 with the wrench base 202. Specifically, the six fastening elements 240 removably couple the stack of the insert plates 1217 with the wrench base 202. Each second hole 1238 of each insert plate 1217 aligns with the corresponding first hole 236 in the wrench base 202 to receive the corresponding fastening element 240.

The wrench assembly 1200 also includes a push plate 1270. The push plate 1270 is received within the slot 214 and is disposed between the insert plates 1217 and the first inner wall 224. The wrench assembly 1200 further includes a pair of push bolts 1280 that engage with the push plate 1270. The pair of push bolts 1280 may be received within the first holes 248 (see FIG. 4A) in the wrench base 202. The push bolts 1280 may facilitate a wedging action between the insert 1216 and the wrench base 202, which may provide a firm joint between the wrench base 202 and the insert 1216 when the wrench assembly 1200 is subjected to break-out loads. It should be noted that the insert 1216 may be split in any other plane or any other way to facilitate break out of joints between drilling components.

It is to be understood that individual features shown or described for one embodiment may be combined with individual features shown or described for another embodiment. The above described implementation does not in any way limit the scope of the present disclosure. Therefore, it is to be understood although some features are shown or described to illustrate the use of the present disclosure in the context of functional segments, such features may be omitted from the scope of the present disclosure without departing from the spirit of the present disclosure as defined in the appended claims.

### INDUSTRIAL APPLICABILITY

The present disclosure is directed towards the wrench assembly 200, 600, 800, 1000, 1100, 1200. The wrench assembly 200, 600, 800, 1000, 1100, 1200 includes the removable insert 216, 616, 816, 1016, 1216 for coupling and/or removing the component 118 from the machine 100. Further, the wrench assembly 200, 600, 800, 1000, 1100, 1200 may allow coupling and/or removal of different sizes of components 118 by replacing the insert 216, 616, 816, 1016, 1216 from the common wrench base 202, 602, 802, 1002 of the wrench assembly 200, 600, 800, 1000, 1100, 1200. For example, the wrench assembly 200, 600, 800, 1000, 1100, 1200 may allow coupling and/or removal of the drill pipes, hammers, or sub adapters of different sizes.

Furthermore, the insert 216, 616, 816, 1016, 1216 may be removably coupled to the wrench assembly 200, 600, 800, 1000, 1100, 1200 in a time efficient manner, without requiring costly/complicated set-ups or high operator expertise. As the common wrench base 202, 602, 802, 1002 of the wrench assembly 200, 600, 800, 1000, 1100, 1200 may be used to couple/remove the components 118 of different sizes, the wrench assembly 200, 600, 800, 1000, 1100, 1200 may reduce costs associated with handling of inventory. The process of removal of the wrench assembly 200, 600, 800, 1000, 1100, 1200 of the present disclosure includes fewer number of steps, which may improve runtime of the machine 100. Furthermore, the insert 216, 616, 816, 1016, 1216 may be easy to handle and thus can be easily replaced after being worn out, which may improve the serviceability of the wrench assembly 200, 600, 800, 1000, 1100, 1200.

The wrench assembly 200, 600, 800, 1000, 1100, 1200 described herein may be simple in construction and may be cost-effective. The engagement portions 242, 642, 842, 1042 of the insert 216, 616, 816, 1016, 1216 may be designed with smooth radius profiles to facilitate easy manufacturing thereof. Further, the insert 216, 616, 816, 1016, 1216 may be easily heat treated for longer wear life thereof. The wrench assembly 200, 600, 800, 1000, 1100, 1200 may also reduce service and maintenance costs associated with the wrench assembly 200, 600, 800, 1000, 1100, 1200. For example, an insert 216, 616, 816, 1016, 1216 of a particular size may be used across multiple machine models which may reduce overall part count as well as costs associated with inventory storage and maintenance.

Further, the wrench assembly 1100 includes the first holes 1236 that are embodied as through holes instead of tapped holes, which may reduce a cost of manufacturing the wrench base 202 associated with the wrench assembly 1100. Furthermore, in some examples, the wrench assembly 1200 may include a number of insert plates 1217 that together form the insert 1216.

While aspects of the present disclosure have been particularly shown and described with reference to the embodiments above, it will be understood by those skilled in the art that various additional embodiments may be contemplated by the modification of the disclosed work machine, systems and methods without departing from the spirit and scope of the disclosure. Such embodiments should be understood to fall within the scope of the present disclosure as determined based upon the claims and any equivalents thereof.

1. A wrench assembly for a machine, the wrench assembly comprising:
a wrench base including a first surface and a second surface opposite the first surface, the wrench base defining a first central opening extending from the first surface to the second surface and a slot extending from at least one of the first surface and the second surface, the wrench base extending along a longitudinal axis, a lateral axis orthogonal to the longitudinal axis, and a vertical axis orthogonal to the longitudinal axis;
an insert removably coupled to the wrench base, and including a third surface and a fourth surface opposite the third surface, the insert defining a second central opening extending from the third surface to the fourth surface, wherein the second central opening is adapted to receive a portion of a component associated with the machine, wherein the insert is received within the slot in the wrench base, and wherein the insert engages with the wrench base to prevent a movement of the insert along the longitudinal axis and at least one of the lateral axis and the vertical axis; and
a plurality of fastening elements that removably couple the insert with the wrench base.

2. The wrench assembly of claim 1, wherein the wrench base includes a first inner wall, a second inner wall, and a third inner wall, each of the first inner wall, the second inner wall, and the third inner wall facing the slot in the wrench base, wherein each of the second inner wall and the third inner wall extend obliquely relative to the first inner wall, and wherein the second inner wall and the third inner wall are inclined to each other.

3. The wrench assembly of claim 2, wherein the insert includes a first outer wall, a second outer wall, and a third outer wall, wherein each of the second outer wall and the third outer wall extend obliquely relative to the first outer wall, wherein the second outer wall and the third outer wall are inclined to each other, and wherein the second inner wall of the wrench base engages with the second outer wall of the insert and the third inner wall of the wrench base engages with the third outer wall of the insert to removably couple the insert with the wrench base to prevent the movement of the insert along the lateral axis of the wrench base.

4. The wrench assembly of claim 1, wherein the wrench base includes a first inner wall, a second inner wall, and a third inner wall, each of the first inner wall, the second inner wall, and the third inner wall facing the slot in the wrench base, and wherein each of the second inner wall and the third inner wall extend obliquely relative to the first surface of the wrench base.

5. The wrench assembly of claim 4, wherein the insert includes a first outer wall, a second outer wall, and a third outer wall, wherein each of the second outer wall and the third outer wall extend obliquely relative to the third surface of the insert, wherein the second outer wall and the third outer wall are inclined to each other, and wherein the second inner wall of the wrench base engages with the second outer wall of the insert and the third inner wall of the wrench base engages with the third outer wall of the insert to prevent the movement of the insert along the vertical axis of the wrench base.

6. The wrench assembly of claim 1, wherein the wrench base includes a first inner wall, a second inner wall, and a third inner wall, each of the first inner wall, the second inner wall, and the third inner wall facing the slot in the wrench base, wherein the wrench base includes a groove facing the slot, and wherein the groove extends from each of the first inner wall, the second inner wall, and the third inner wall.

7. The wrench assembly of claim 6, wherein the insert includes a first outer wall, a second outer wall, and a third outer wall, wherein the insert includes a projection extending orthogonally from each of the first outer wall, the second outer wall, and the third outer wall, and wherein the projection is received within the groove in the wrench base to prevent the movement of the insert along the vertical axis of the wrench base.

8. The wrench assembly of claim 1, wherein the wrench base defines a plurality of first holes, and wherein the insert defines a plurality of second holes that align with a corresponding first hole from the plurality of first holes in the wrench base to receive a corresponding fastening element from the plurality of fastening elements.

9. The wrench assembly of claim 1, wherein the insert includes a plurality of insert plates disposed in a stacked configuration.

10. The wrench assembly of claim 1, wherein the component includes at least one of a drill pipe, a hammer, and a sub adapter.

11. A drilling machine comprising:
a mast assembly;
a drill head movable relative to the mast assembly;
a component adapted to be coupled to the drill head to perform a drilling operation; and
a wrench assembly adapted to engage with the component during at least one of coupling and removing the component from the drill head, the wrench assembly including:
a wrench base including a first surface and a second surface opposite the first surface, the wrench base defining a first central opening extending from the first surface to the second surface and a slot extending from at least one of the first surface and the second surface, the wrench base extending along a longitudinal axis, a lateral axis orthogonal to the longitudinal axis, and a vertical axis orthogonal to the longitudinal axis;
an insert removably coupled to the wrench base, and including a third surface and a fourth surface opposite the third surface, the insert defining a second central opening extending from the third surface to the fourth surface, wherein the second central opening is adapted to receive a portion of the component associated with the drilling machine, wherein the insert is received within the slot in the wrench base, and wherein the insert engages with the wrench base to prevent a movement of the insert along the longitudinal axis and at least one of the lateral axis and the vertical axis; and
a plurality of fastening elements that removably couple the insert with the wrench base.

12. The drilling machine of claim 11, wherein the wrench base includes a first inner wall, a second inner wall, and a third inner wall, each of the first inner wall, the second inner wall, and the third inner wall facing the slot in the wrench base, wherein each of the second inner wall and the third inner wall extend obliquely relative to the first inner wall, and wherein the second inner wall and the third inner wall are inclined to each other.

13. The drilling machine of claim 12, wherein the insert includes a first outer wall, a second outer wall, and a third outer wall, wherein each of the second outer wall and the third outer wall extend obliquely relative to the first outer wall, wherein the second outer wall and the third outer wall are inclined to each other, and wherein the second inner wall of the wrench base engages with the second outer wall of the insert and the third inner wall of the wrench base engages with the third outer wall of the insert to prevent the movement of the insert along the lateral axis of the wrench base.

14. The drilling machine of claim 11, wherein the wrench base includes a first inner wall, a second inner wall, and a third inner wall, each of the first inner wall, the second inner wall, and the third inner wall facing the slot in the wrench base, and wherein each of the second inner wall and the third inner wall extend obliquely relative to the first surface of the wrench base.

15. The drilling machine of claim 14, wherein the insert includes a first outer wall, a second outer wall, and a third outer wall, wherein each of the second outer wall and the third outer wall extend obliquely relative to the third surface of the insert, wherein the second outer wall and the third outer wall are inclined to each other, and wherein the second inner wall of the wrench base engages with the second outer wall of the insert and the third inner wall of the wrench base engages with the third outer wall of the insert to prevent the movement of the insert along the vertical axis of the wrench base.

16. The drilling machine of claim 11, wherein the wrench base includes a first inner wall, a second inner wall, and a third inner wall, each of the first inner wall, the second inner wall, and the third inner wall facing the slot in the wrench base, wherein the wrench base includes a groove facing the slot, and wherein the groove extends from each of the first inner wall, the second inner wall, and the third inner wall.

17. The drilling machine of claim 16, wherein the insert includes a first outer wall, a second outer wall, and a third outer wall, wherein the insert includes a projection extending orthogonally from each of the first outer wall, the second outer wall, and the third outer wall, and wherein the projection is received within the groove in the wrench base to prevent the movement of the insert along the vertical axis of the wrench base.

18. The drilling machine of claim 11, wherein the wrench base defines a plurality of first holes, and wherein the insert defines a plurality of second holes that align with a corresponding first hole from the plurality of first holes in the wrench base to receive a corresponding fastening element from the plurality of fastening elements.

19. The drilling machine of claim 11, wherein the insert includes a plurality of insert plates disposed in a stacked configuration.

20. The drilling machine of claim 11, wherein the component includes at least one of a drill pipe, a hammer, and a sub adapter.
